(19) United States
(12) Patent Application Publication
(10) Pub. No.: US 2005/0151708 A1
(43) Pub. Date: Jul. 14, 2005

(54) LED module with uniform LED brightness

(76) Inventors: Ronald E. Farmer, Houston, TX (US); Christiaan Coenraad Joubert Smit, Allen, TX (US)

Correspondence Address: AKIN, GUMP, STRAUSS, HAUER & FELD, 1111 LOUISIANA STREET, 44TH FLOOR, HOUSTON, TX, 77002, US

(21) Appl. No.: 10/756,545

(22) Filed: Jan. 12, 2004

(51) Int. Cl. G09G 3/32

(52) U.S. Cl. 345/82

(57) ABSTRACT

An LED module provides one or more LEDs serially mounted with a circuit board assembly. A substantially constant current power source is operably connected to a power supply and to the plurality of LEDS, whereby each of the LEDs emits light at a substantially uniform level of brightness. In one embodiment, the LED may be mounted on a separate board from the power supply. A system of LED modules can be constructed from multiple LED modules, each producing a substantially uniform predetermined level of brightness. The system of LED modules may be electrically disconnected from each other.

### CROSS-REFERENCE TO RELATED APPLICATIONS

This application claims priority to U.S. Provisional Application No. ______ filed Jan. 17, 2003.

### BACKGROUND OF THE INVENTION

1. Field of the Invention

The invention relates generally to the field of lighting systems utilizing light emitting diodes (“LEDs”). More specifically, the invention relates to luminescent lighting displays using white light LED systems to provide lighting effects or signage.

2. Description of the Related Art

Luminescent lighting displays, such as cabinet and flat panel signs, billboards, storefront awnings, and the like, often utilize illuminated signage fixtures commonly referred to as “channel letters” to produce a variety of lighting effects. Such channel letters typically comprise one or more channels, with internal light sources, each channel being shaped as a letter, number, design, or a combination thereof, and each generally having a rigid, translucent plastic cover. The term “lighting displays” also includes architectural lighting, interior lighting for homes and businesses, and other applications where it is desirable to provide evenly bright, long-lasting lighting with low-power requirements.

The common light sources, such as fluorescent lamps, halogen lamps, gaseous discharge xenon lamps, neon lights, and the like, have been used in such lighting displays and fixtures, such as channel letters, for illuminated signs. These types of light sources typically convert a significant portion of the energy consumed into heat that may be difficult to dissipate from a sealed display, and may damage electronic circuitry contained therein. In addition, these lamps consume significant amounts of current, and typically require large power supplies or transformers. Some of these lamps and power supplies also generate substantial electromagnetic emissions, which may interfere with radio communications and thus can be problematic in certain applications and locations. Finally, these light sources may have a relatively short operational life, necessitating frequent replacement.

As a result of these known problems with traditional lighting sources, there are many potential areas of application in luminescent lighting displays for light-emitting diodes (“LEDs”). This is because LED systems among other advantages enable creation of a light display that: (1) is far more durable than present sources in common use; (2) is modular and, therefore, more adaptable; (3) has an extraordinarily long life span; (4) is portable; (5) operates in damp conditions; and (6) uses lower voltage, producing a light display that is much safer to use, install, service and less expensive to operate.

An LED is a current-driven device, meaning that the light output is roughly linearly related to the current that passes though it. In the fabrication of effective channel letter signage, it is important that all LEDs emit at a comparable light level in order to give a uniform light distribution on the translucent rigid plastic cover (usually PLEXIGLAS acrylic polymer, or LEXAN polycarbonate polymer) of the channel letter.

In many areas of application for LED illuminated displays, there is an increasing demand for LED configurations with polychromatic light, in particular white light, and for a light source that stays relatively constant in brightness. In fact, a better efficiency can be obtained combining LEDs of the main component colors together to produce white light, as disclosed in U.S. Pat. No. 5,731,794. However, white light is difficult to maintain constant with LEDs of different colors, because ageing and exposure of the LEDs to high temperature changes their brightness.

It is known to utilize a constant voltage source to power LEDs. However, in such a case, the fact that every single LED has unique voltage-current characteristics must be taken into account. This is because the current usage, and hence the light output, of an LED will change from LED to LED if powered by a constant voltage. This effect is aggravated by voltage losses in the wire used to connect the power source to the LEDs and the LEDs to each other, as well as by the power source if it has poor regulation characteristics.

It is thus more difficult to obtain uniform light distribution in an electric sign application if a constant voltage power source scheme is used as compared to a constant current source. However, insofar as known, all LED-based light systems used in electric signs use a voltage control scheme to power their LED system and maintain the voltage to the LED system constant. Light uniformity problems associated with voltage control schemes have been dealt with in the past by imposing special wiring rules and/or by using LEDs that have been tested and found to have relatively similar voltage characteristics.

Moreover, to our knowledge, all LED based illumination systems typically use a centralized power source to supply the LED modules connected to the power source. The purpose of the power supply is to step the main voltage down to a level appropriate for driving the LEDs and in most cases also to convert the voltage from AC to DC.

In sum, a need exists to utilize a constant current power supply rather than a constant voltage power supply for LED modules, both in individual LED modules and in LED modules physically and electrically connected in series, in order to produce uniform LED brightness and lighting quality. While the concept of providing constant current may have been used in other applications previous to the invention, insofar as known, no one has applied constant current technology to LED modules in electric sign applications.

### BRIEF SUMMARY OF THE INVENTION

As used herein, the term “LED” is intended to refer generally to light emitting diodes of all types, but also should be understood to include any kind of similar system that is capable of receiving an electrical potential and producing a color of visible or ultraviolet (UV) light in response to the resulting electrical current. Thus, the intent is to include such systems as light emitting diodes, semiconductor dies that produce light in response to current, organic LEDs, electro-luminescent strips, silicon based structures that emit light, and other such systems.

In specific discussions of an embodiment herein, the term “LED” may refer to a single light emitting diode package having multiple semiconductor diodes that are individually controlled. It should also be understood that the term “LED” is not restricted to the package type of LED. The term “LED” includes packaged LEDs, non-packaged LEDs, surface mounted LEDs, chip mounted on board LEDs and LEDs of all other configurations. The term “LED” also includes LEDs packaged or associated with phosphor wherein the phosphor may convert energy from the LED to a different wavelength.

The term “illuminate” should be understood to refer to the production of a frequency of radiation by an illumination source with the intent to illuminate a space, environment, material, object, or other subject. The term “color” should be understood to refer not only to any frequency of radiation, or combination of different frequencies, within the visible light or ultraviolet spectrum. The use of any specific color is exemplary and illustrative only, and any other color or combination of colors can be used. The use of any specific color name does not imply a particular frequency of light.

The term “LED modules” should be understood to refer to an LED system that contains at least one LED with associated electronic circuitry to drive the LED(s). Each LED module also contains connectors that are adapted for connection to other LED modules. LED modules are directly powered from a voltage that can range from 24V to 277V AC or DC to energize the LEDs. This essentially means that the LED modules can be directly powered from a main 120V/220V/240V/277V supply, or other suitable power supply, without causing variation to the light of the LEDs utilizing the principles of this invention.

Accordingly, the LED system of the present invention uses a current control system in order to maintain current and therefore light level substantially constant or uniform. As pointed out earlier, this ensures that a single LED is illuminated at a predesignated level or that two or more LEDs are illuminated at substantially the same level, resulting in a uniform LED illumination without requiring special wiring or specially selected LEDs. This is achieved by placing a constant current source on an LED module or in electrical connection to a constant current providing circuit. The constant current source LED system of the present invention therefore uses a distributed power supply in that each LED module has its own power supply. A centralized power supply has a limited power delivery capability, which limits the number of LED modules that can be supplied. By tapping directly into the main power supply, the constant current source LED system of the present invention can implement a much larger number of LED modules. A second advantage of high voltage operation is that the current passing through the wires that supply the LED modules is lower than in a similar system running off a low voltage. An advantage of using lower current is that smaller gauge wire can be used. Alternatively, if large gauge wire is preferred, the system would run more efficiently due to less copper losses in the wire.

It is an object of this invention to provide LED modules, each comprising one or more LEDs driven by constant current to provide substantially uniform light emission.

It is accordingly a further object of the invention to provide a white LED module system to be used as a lighting system that will replace white neon and other types or colors of LED light sources in illuminated channel letter sign applications or other lighting displays, while operating consistently and efficiently.

These and other objects are provided, in accordance with the invention, by an LED module comprising one or more LEDs mounted in a circuit board, with a power supply operably connected to a circuit board assembly. Each LED is serially mounted with the circuit board assembly, and a substantially constant current source is operably connected to said power supply and to said serially mounted LED, whereby each LED is driven by substantially the same current, in order to emit light at a substantially uniform level of brightness. Each LED module may also contain connectors that can be connected to other LED modules and which can be used to supply power from module to module. In another embodiment, a constant current module is operably connected to one or more sets to LEDs in order to drive such LEDs at substantially constant current.

### BRIEF DESCRIPTION OF THE DRAWINGS

FIG. 1 is a circuit diagram of an LED module of a preferred embodiment of this invention;

FIG. 2 is a top view of an LED module of this invention illustrating the placement of two LEDs adjacent the edges of a printed circuit board assembly in a preferred embodiment of this invention; and

FIG. 3 is a circuit diagram of an LED module of another preferred embodiment of this invention; and

FIG. 4 is a circuit diagram of a power supply module of the embodiment of FIG. 3; and

FIG. 5 is a block diagram of a system of LED modules.

### DETAILED DESCRIPTION OF THE INVENTION

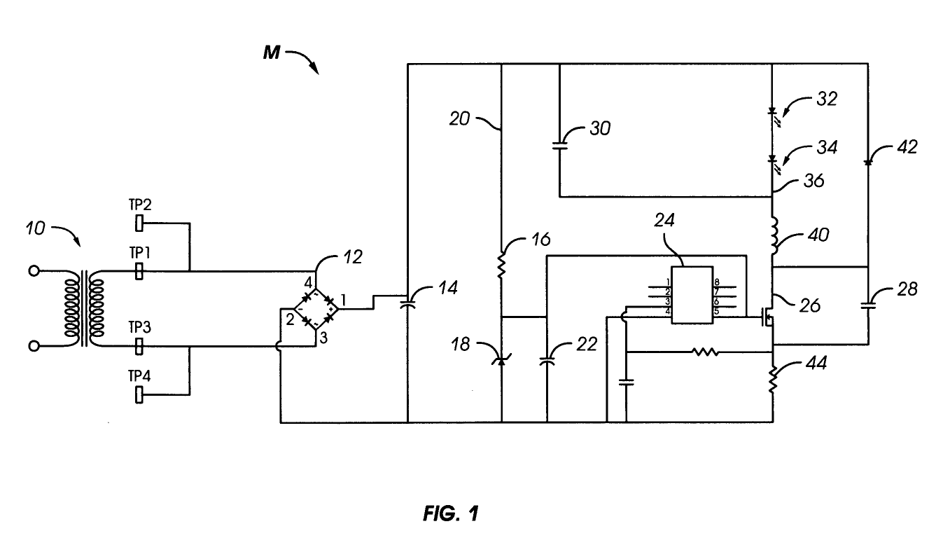

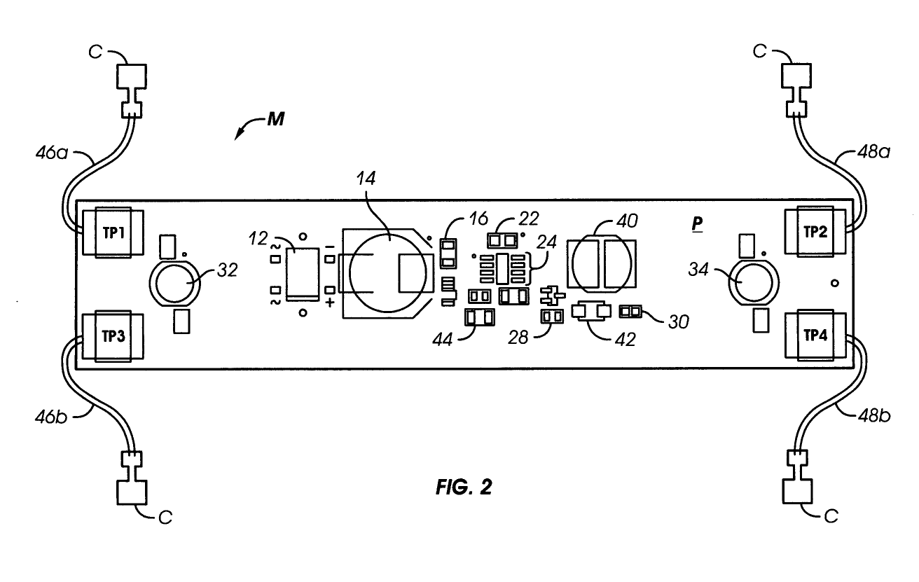

The LED module system of the present invention is, in one embodiment, a lighting system that can be used to replace white neon in electric sign applications, among other uses. The system consists of one or more LED modules M as a light source, each containing two or more white LEDs along with the electronic circuitry of FIGS. 1 and 2 to drive the LEDs. The color “white” as used herein is exemplary and illustrative only, and other colors and combinations of colors may be used.

It is to be understood that the circuitry of this invention controls one or more LEDs in such a way that the light output remains substantially constant regardless of voltage fluctuations in the primary power or any voltage drops on the wires on the transformer's secondary side. In this manner, the power supply is “distributed” in that each module M has its own current controlled power supply. This control scheme substantially eliminates the “voltage binning” and “luminous flux binning” problems that are typically associated with LEDs, allowing LEDs from different bins to be operated at substantially the same brightness level. “Voltage binning” is a technique used by LED manufacturers to group or bin LEDs with similar voltage characteristics. Voltage binning is, however, only a problem if the LEDs are voltage controlled. This invention uses a current control scheme that substantially eliminates the need for voltage binning. “Luminous flux binning” is a technique used by LED manufacturers to group or bin LEDs with similar light level characteristics. The current controlled power supply can compensate for differences in LED lamp luminous flux characteristics by controlling the current (and therefore the light) that passes through the LEDs.

The constant current distributed power supply disclosed here has at least the following advantages:
LEDs of different voltage and luminous flux bins can be mixed without causing light uniformity problems; and
Light is uniform across the entire surface of the translucent rigid plastic letter face.
   Other advantages may be apparent to one skilled in the art.

Referring to the drawings, FIG. 1 illustrates a schematic of the circuitry of one embodiment of this invention for an LED module generally designated as M. Thus, while FIG. 2, which will be described in greater detail hereinafter, illustrates a completed assembly for the LED module M of the preferred embodiment of this invention, FIG. 1 represents a schematic of circuitry to obtain a substantially uniform brightness level for the LEDs located on the LED module M. Uniformity of LED brightness can be controlled by choice of current levels and LEDs. Uniformity of light between modules can be achieved by driving the modules at appropriate current levels. If multiple LEDs are used on a given module, then LEDs of the same flux type should be used for all LEDs on that module to achieve uniformity of light across the module. A main power supply (not shown) is operably connected to the transformer 10, which connects to contact pads or nodes TP1 and TP3. The power supplied through the transformer 10 can be stepped down to an acceptable voltage level; however, it should be understood that a transformer 10 may not be required by the LED module M. Typically, the output of the transformer 10 across contacts TP1 and TP3 will provide the maximum voltage allowed by local regulatory authority or by other design considerations.

For example, in countries that require the LED system to comply with a Class 2 or similar regulation, the transformer 10 can be used to step down from the main supply voltage (e.g. 120V AC) to a voltage that conforms to regulation (e.g. 30V in the case of Class 2). The transformer's output voltage is typical chosen to be the maximum voltage allowed by the regulatory body to actually power the individual LED circuits.

The transformer 10 delivers stepped-down AC power to full bridge rectifier 12, which converts the alternating current to a pulsed positive DC voltage. Capacitor 14 is provided across nodes 1 and 2 of the rectifier 12 to smooth out the pulsed positive DC voltage, which in the preferred embodiment of this invention, is in the range of 28-35 volts. However, it should be understood that the actual voltage utilized may vary according to application and yet be within the scope of this invention. Further, although as shown in FIG. 1 for use with AC power, in other embodiments, DC power can be used, which may eliminate the need for the transformer 10, bridge 12, and capacitor 14. Resistor 16 is in serial connection with Zener diode 18 along conductor 20, with resistor 16 and diode 18 being parallel to smoothing capacitor 14. Resistor 16 and Zener diode 18 cooperate with capacitor 22, which is parallel to the Zener diode 18, to reduce the voltage from the range of 28-35 volts to about 14-16 volts across current mode controller 24. In embodiments supplying lower voltages, these elements may be omitted. A current mode controller 24 utilized in the preferred embodiment of this invention, which is an NCP 1200, operates in a switch mode to open and close 100,000 times per second. Other current mode controllers and operating rates may be used. The integrated current switch mode controller 24 of the preferred embodiment is an 8 pin device, with pin 5 being connected to an N-channel FET semiconductor switch 26, which is in parallel connection to capacitor 28. Capacitor 30 is in parallel connection with the actual LEDs 32 and 34 located in circuit branch 36. The LEDs 32 and 34 may be LEDs manufactured by Lumileds Lighting, LLC, 370 West Trimble Road, San Jose, Calif. 95131, under the brand name LUXEON. LEDs 32 and 34 are typically “P-BIN” LUXEON LEDs having a current operating range of approximately 350 mA. It should be understood that “Q-BIN” LEDs and other types of LEDs of other manufacturers may be utilized in the alternative. For example, “Q-BIN” LEDs of LUXEON are typically 30% brighter LEDs than P-BIN LEDs for a given current level, and operate in the range of approximately 270 mA to achieve uniform light output with modules using P-BIN LEDs. If Q-BIN LEDs of LUXEON, for example, are utilized instead of the P-BIN LEDs, minor modifications may be made to the circuitry shown in FIG. 1, as would be known to a person of ordinary skill in the art. It should be understood that these LUXEON brand LEDs and current levels are exemplary and illustrative only, and other LEDs and current levels, depending on the choice of LED and desired brightness, may be used to achieve a predetermined brightness and light output.

Inductor 40 is located in branch 36 in series with LEDs 32 and 34 such that the serially connected LEDs 32 and 34 are in a parallel connection with a super-fast “flyback” diode 42. The inductor 40 assists in keeping the current flowing through LEDs 32 and 34 at a constant level.

In operation, when the current mode controller switch 24 is closed, current flows through LEDs 32 and 34, the inductor 40, and diode 42 to energize the LEDs 32 and 34. In the preferred embodiment, when the current in switch mode controller 24 exceeds 430 mA, the switch is opened such that the current traveling through LEDs 32 and 34 and inductor 40 is redirected to pass through flyback diode 42. In this manner, the current within branch 36 flowing across LEDs 32 and 34 and inductor 40 keeps flowing. The energy to maintain current flow is provided by the inductor 40. During an off cycle of transistor 26, the current decreases and reaches a level of 270 mA. At this point, transistor 26 closes again and the cycle repeats. This cycle repeats at a rate of 100,000 times per second. Thus, the average current passing through the LEDs 32 and 34 is approximately 350 mA (the average of 270 mA and 430 mA). It should be understood that, while it is desirable that the current be maintained at least at an approximate average of 350 mA, because the power supplied to current mode controller switch 24 is a rippled, pulsed positive direct current, the actual current may vary across a range of perhaps 100 mA, such as between 300 and 400 mA. By utilizing the current mode controller 24 in conjunction with inductor 40 in serial connection with LEDs 32 and 34, a substantially constant current is provided to the LEDs 32 and 34, thus providing a substantially uniform predetermined brightness output to the viewer. The above current levels and cycle repetition rates are exemplary and illustrative only, and other current levels and cycle repetition rates can be used.

Referring now to FIG. 2, a printed circuit board P for the LED module M of the preferred embodiment of this invention is illustrated, with the same numbers and letters as utilized in FIG. 1 identifying the same electrical components. The printed circuit board P illustrated in FIG. 2 from a top view is substantially similar to a printed circuit board manufactured in accordance with the “Luxeon Assembly Process and Metal Core Printed Circuit Board Information” copyrighted 2001 by Lumileds Lighting, LLC (Publication No. AB10 (March 2002)), which is incorporated by reference in its entirety herein for all purposes. The printed circuit board P as taught by Lumileds Lighting, Inc. (hereinafter “Lumileds”) is of the metal clad type, utilizing copper circuit traces over a dielectric with an aluminum clad. The printed circuit board P, which is shown in a rectangular configuration, but which can be implemented in other configurations, locates the connector pads TP1 and TP3 on or substantially adjacent the left edge of the printed circuit board P, with connector pads TP2 and TP4 being located on the right edge of the printed circuit board R The locations of the connector pads TP1-TP4 are exemplary and illustrative only, and other locations can be used.

The connector pads TP1 and TP3 are electrically attached to conductor wires 46a and 46b, respectively. Similarly, conductor wires 48a and 48b are electrically attached to contacts TP2 and TP4, respectively, located at or substantially adjacent the right edge of the printed circuit board. Each of the connector wires 46a-b and 48a-b terminate in quick-connectors C which are plastically shielded. Other connector types may be used. One of the 46a-b and 48a-b set of wires terminate in male connectors while the other set of wires terminate in female connectors. It should be understood that while two wire conductors are illustrated at or substantially adjacent each side edge of the printed circuit board P, the actual number of conductor wires may vary and yet be within the scope of this invention. Further, the printed circuit board may be manufactured in accordance with the LUXEON assembly process or other appropriate printed circuit board technology which allows for the necessary transfer of heat from the LEDs 32 and 34, which may be located substantially adjacent to connector contact pads TP1-TP3 and TP2-TP4, respectively. The use of connector pads TP1-TP4 allow connecting multiple LED modules M together if desired.

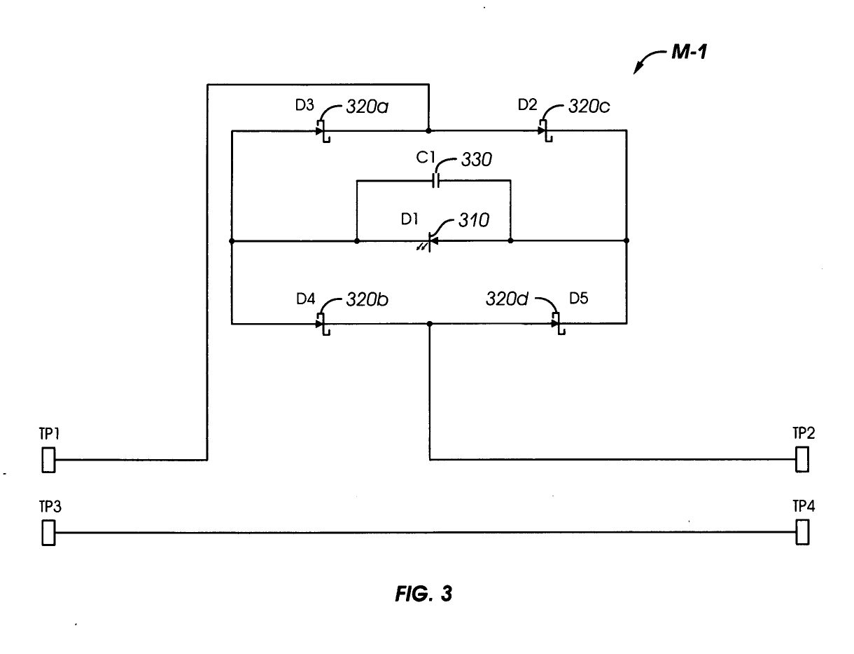

FIG. 3 is a circuit diagram of an LED module M-1 according to another preferred embodiment. In this embodiment, the LED module M-1 is configured for a single LED 310, and does not contain the power supply circuitry of the module M of the preferred embodiment of FIGS. 1 and 2, which is contained in a separate power supply module 400 as described below.

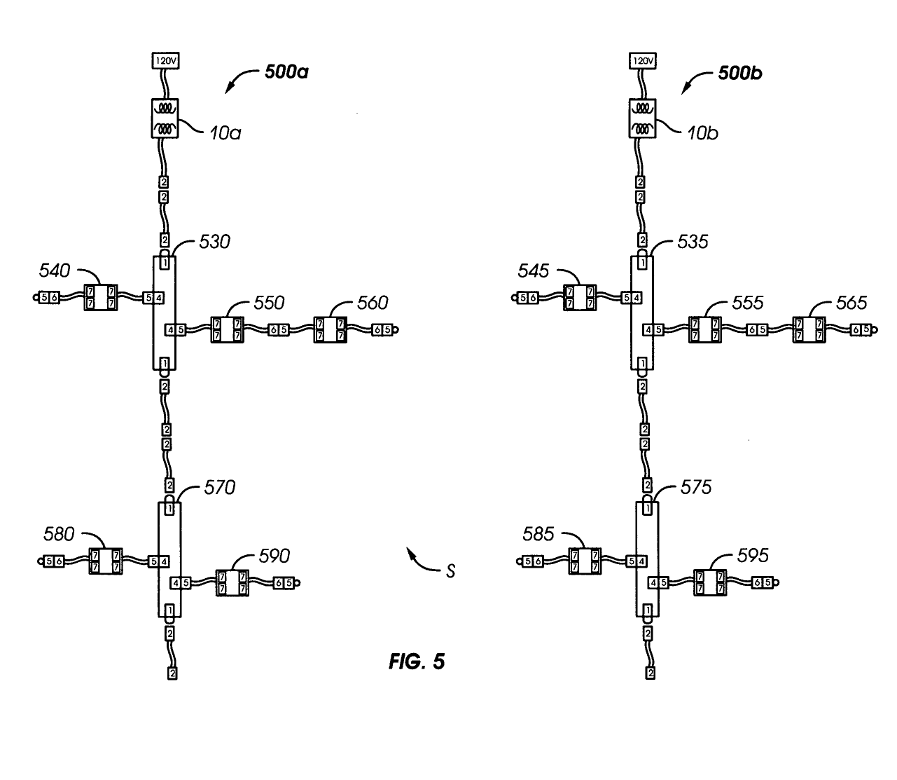

In this embodiment of FIG. 3, Schottky diodes 320a-320d allow the connectors TP1 and TP2 to be connected without regard to voltage polarization, preventing reverse voltage from being applied to the LED 310, which could damage the LED 310. The capacitor 330 corresponds to the capacitor 30 for the embodiment of FIG. 1 and can be used to provide voltage filtering for the LED 310. Although shown with a single LED 310, FIG. 3, as with the embodiment of FIG. 1, any number of LEDs can be used in the LED module M-1. In embodiments with multiple LEDs 310, each LED 310 is connected in series, similar to the two-LED embodiment of FIG. 1. Where a multi-LED module is configured, a single capacitor 330 can be used, as shown in FIG. 3, or individual capacitors 330 can be configured, one per LED 310, connected in parallel to that LED 310. The capacitors 330 are optional and can be omitted. Connectors TP2 and TP4 allow a chain of LED modules M-1 to be created, as shown in FIG. 5 and described in detail below.

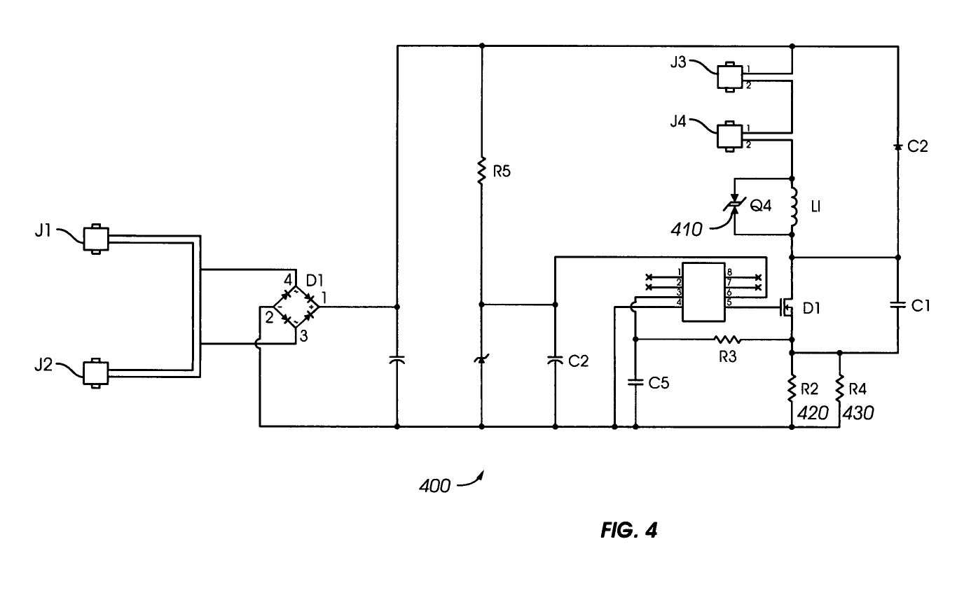

Turning to FIG. 4, a power supply unit module 400 is shown for the embodiment M-1 using separated LED modules as in FIG. 3. Connector J1 corresponds to the pads TP1 and TP3 of FIG. 1, while connector J2 corresponds to pads TP2 and TP4 of FIG. 1, allowing chains of power supply units 400 to be connected to each other. Connectors J3 and J4 allow the power supply unit to be connected to connectors TP1 and TP3 or connectors TP2 and TP4 of a plurality of LED modules 300. Although shown with two connectors J3-J4 for LED modules, any number of LED module connectors can be provided.

A transient voltage suppressor 410 provides protection against voltage surges if an LED module 300 be disconnected from the power supply unit 400 while connected to a main power supply. Resistors 420 and 430 illustrate an alternate embodiment for the resistor 44 of FIG. 1, allowing the use of multiple lower current-rated resistors instead of a single resistor 44. Otherwise, the circuit of power supply 400 is identical to that of the LED module M of FIG. 1, except that power supply circuit 400 does not contain any LEDs, which are located on separated LED module M-1.

FIG. 5 illustrates a system S of LED modules in various lighting display applications. The system S includes one or more power supply units such as 530 (which is the same as the power supply unit of FIG. 4) connected to separated LED modules such as 540, which do not contain a power supply or constant current circuit. The system S provides for creating one or more subsystems of modules providing a predetermined uniform brightness, even though subsystem 500a may be electrically disconnected from subsystem 500b. The system of FIG. 5 is exemplary and illustrative only, and can be implemented as a single connected system, such as subsystem 500a or any number of multiple disconnected subsystems, such as 500a and 500b and one or more LED modules M of FIGS. 1 and 2.

As shown in FIG. 5, subsystems 500a and 500b are identical, and are constructed using separated LED modules and power supply units of the embodiments of FIGS. 3-4. However, LED modules of the embodiment of FIGS. 1-2 can be used instead of or in combination with the separated LED modules and power supply units of the embodiments of FIGS. 3-4 as desired.

Subsystem 500a shows two power supply units 530 and 570 (each identical to unit 400 of FIG. 4), connected to separated LED modules 540-560 and 580-590 respectively. Similarly, subsystem 500b shows power supply units 535 and 575, connected to separated LED modules 545-565 and 585-595. The arrangement and number of separated LED modules is exemplary and illustrative and other arrangements, number of separated LED modules, and the number of LEDs in each separated LED module and connections can be used to provide a variety of systems. As exemplified by LED module 540, when no further separated LED modules are to be chained to LED module 540, the connectors TP2 and TP4 are shorted together.

While certain exemplary embodiments have been described in detail and shown in the accompanying drawings, it is to be understood that such embodiments are merely preferred and only illustrative of and not restrictive on the broad invention. Other and further embodiments of the invention may be devised without departing from the basic scope thereof, which is determined by the claims that follow. By way of example, and not limitation, the specific electrical components utilized may be replaced by known equivalents or other arrangements of components which function similarly and provide substantially the same result. The number of wire leads or connectors may vary with the application. The source of power may be adjusted or modified in accordance with local electrical installation regulations or for other reasons without deviating from the principles of this invention, and other similar changes can be made by persons of ordinary skill in this art without deviating from the principles of this invention. The LED modules of FIG. 1 may be combined with the separated power supply units such as 530, which connect to separated LED modules such as 540 or 550-560. Then the ultimate lighting display of the invention includes anywhere from one LED to multiple LEDs, driven by a substantially constant or substantially the same current (depending on the particular LEDs used) to produce anywhere from a single LED of a desired brightness to a plurality of LEDs having substantially the same brightness.

1-18. (canceled)

19. An LED module, comprising:
(a) a circuit board assembly;
(b) a first LED mounted with said circuit board assembly;
(c) a substantially constant current circuit mounted with said circuit board assembly and operably connected to said first LED; and
(d) a power supply assembly mounted with said circuit board assembly and operably connected to said substantially constant current circuit whereby the LED is provided with substantially constant current within an operating range to substantially produce a predesignated level of brightness.

20. The LED module of claim 19, wherein said power supply includes:
(a) a supply of alternating power current; and
(b) a rectifier or other means operably connected to said supply of alternating power to convert said alternating power current to direct power current.

21. The LED module of claim 19, comprising:
(a) said power supply assembly including a source of alternating current operably connected to a step-down transformer mounted with said circuit board assembly.

22. The LED module of claim 19, wherein said substantially constant current source comprises:
(a) said substantially constant current circuit operably connected to said power supply and to said first LED in order to power the first LED with substantially constant current, whereby said first LED emits light at a substantially predetermined level of brightness.

23. The LED module of claim 19, wherein:
(a) said substantially constant current circuit includes an inductor and switch combination;
(b) the first LED is serially connected to said inductor and switch combination to operate said first LED in a substantially constant current range.

24. The LED module of claim 19, wherein:
(a) said circuit board assembly is generally rectangular in configuration and has opposing side edges; and
(b) said first LED is located adjacent to one of the side edges.

25. The LED module of claim 19, wherein:
(a) a second LED is mounted with said first LED and is driven by said substantially constant current circuit whereby said first and second LEDs are operated with substantially the same operating range to produce substantially the same level of brightness.

26. The LED module of claim 25, further comprising:
(a) a second LED module comprising a second circuit board assembly, a third LED mounted with said second circuit board assembly, a second substantially constant current circuit mounted with said second circuit board assembly operably connected to said third LED, and
(b) means for electrically connecting said first and second LED modules together to form a lighting system.

27. The LED modular system of claim 26, further including:
(a) a fourth LED mounted with said second circuit board assembly in series with said third LED, said second substantially constant current power supply operably connected to the third and fourth LEDs whereby said third and fourth LEDs are operated at substantially the same level of brightness.

28. The modular system of claim 27, including:
(a) said first, second, third and fourth LEDs being driven by substantially the same level of current whereby the first, second, third and fourth LEDs have substantially uniform light emission.

29. The modular system of claim 28, including:
(a) said first and second LEDs operating in substantially the same current range to produce a certain level of brightness; and
(b) said second and fourth LEDs operating in a current range different from the current range of said first and third LEDs to produce said certain level of brightness which is substantially the same as said level of brightness of said first and second LEDs.

30. An LED modular lighting system, comprising:
(a) a first independent LED power module, said first LED independent power module including a first power supply mounted with a first circuit board assembly operably connected to a first substantially constant current circuit mounted with said first circuit board assembly;
(b) a first separate LED unit, said first separate LED unit including a first LED mounted on a first separate LED circuit board; and
(c) said first LED power module operably connected to said first, separate LED unit whereby said first LED power module and said first separate LED unit cooperate to provide a substantially constant predesignated current to said first LED in order to produce a predesignated level of brightness.

31. The LED modular lighting system of claim 30, further including:
(a) a second separate LED unit, said second separate LED unit including a second LED mounted on a second separate LED circuit board, said second LED unit being operably connected to said first independent LED power module whereby said first independent LED power module drives said first and second LEDs located on separate LED circuit boards at a substantially uniform level of current and LED brightness.

32. The LED modular lighting system of claim 31, further including:
(a) said second LED unit including a third LED mounted on said second separate LED circuit board whereby said first, second and third LEDs are driven at substantially the same current to produce substantially the same level of brightness.

33. An LED modular light system, including:
(a) a circuit board assembly;
(b) a first LED mounted with said circuit board assembly;
(c) a substantially constant current circuit mounted with said circuit board assembly and operably connected to said first LED;
(d) a first independent LED power module, said first LED independent power module including a first power supply mounted with a first circuit board assembly operably connected to a first substantially constant current circuit mounted with said first circuit board assembly;
(e) a first separate LED unit, said first separate LED unit including a first LED mounted on a first separate LED circuit board; and
(f) said first LED power module operably connected to said first, separate LED unit whereby said first LED power module and said first separate LED unit cooperate to provide a substantially constant predesignated current to said first LED in order to produce a predesignated level of brightness.
